(19) United States
(12) Patent Application Publication
(10) Pub. No.: US 2019/0015784 A1
(43) Pub. Date: Jan. 17, 2019

(54) Capacitive Electro Dialysis Reversal

(71) Applicant: Ben Harrison Cantrell, Springfield, VA (US)

(72) Inventor: Ben Harrison Cantrell, Springfield, VA (US)

(21) Appl. No.: 15/447,641

(22) Filed: Mar. 2, 2017

(51) Int. Cl. B01D 61/50; C02F 1/469; C02F 1/46

(52) U.S. Cl. CPC B01D 61/50; C02F 1/4693; C02F 1/4691; C02F 2103/08; B01D 2313/345; B01D 2313/365; C02F 1/4604

(57) ABSTRACT

This Capacitive Electro Dialysis Reversal (CEDR) invention desalinates and concentrates saline water. The CEDR unit employs two identical parallel oppositely oriented modified Electro Dialysis Reversal EDR constructions that have shared dilute and concentrated saline water channels. The four electrodes of the two identical oppositely oriented parallel EDR like constructions are replaced with four supercapacitor electrodes. Each EDR like construction consists of a stack of ion exchange membranes and spacers plus the supercapacitor electrodes but one cation exchange membrane is trimmed from each of the two stacks of EDR like ion exchange membranes. During a cycle of operation, the supercapacitor electrodes discharge and then charge causing ions to be pulled out of the shared dilute saline water channels and placed in the shared concentrated saline water channels except at the ends where the ions flow in and out of the supercapacitor electrodes. The two adjacent supercapacitor electrodes on either end are exchanged between the two-modified parallel EDR like constructions at the end of each cycle of operation. This process of supercapacitor discharging and charging and then exchanging places operates continuously. A benefit of this CEDR invention is that no gasses are formed at the supercapacitor electrodes like EDR does using conducting electrodes but a similar performance to that of EDR is maintained. A feature of this CEDR invention is that almost all the energy delivered to it is used in desalination and saline water concentration while energy losses at the supercapacitor electrodes located at the ends of the CEDR unit are very small and negligible.

### CROSS-REFERENCE TO RELATED APPLICATIONS

Not Applicable

### FEDERALLY SPONSORED RESEARCH OR DEVELOPMENT

Not applicable

### REFERENCE TO A “SEQUENCE LISTING”

Not Applicable

### NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND

### Field of the Invention

The field of this invention is to provide ion transfer from one saline water to another saline water such that one of the saline waters becomes more concentrated in salinity while the other one becomes diluted in salinity. When the product water is diluted in salinity after the ion transfer process, the process is called desalination.

### Description of the Related Art

Because of current and predicted fresh water shortages, desalination equipment is currently being used and new equipment is being developed to provide fresh water from saline water that is too salty for normal use. Although there are a variety of and variations of desalination equipment, the two most widely used methods are: (a) Distillation which uses thermal energy to evaporate mostly pure water from saline water and then condenses the rather pure water vapor to become fresh water and (b) Reverse Osmosis which uses water pressure to force saline water against a porous membrane which allows the fresh water to pass on through the membrane while the now more saline water stays behind. Both methods rely on separating fresh water from the saline water.

Two more well-known desalination processes, but not as widely used, are: (a) Electro Dialysis Reversal (EDR) described in Non-Patent Literature Document [1] and (b) Capacitive Deionization described in Non-Patent Literature Document [2]. These two processes transfer ions from one independent saline water to another independent saline water making one saline water more saline and the other less saline. EDR is constructed from a stack of alternating cation and anion exchange membranes where there are alternating dilute and concentrated saline water channels between each pair of ion exchange membranes. This arrangement plus conducting electrodes emerged in saline water at each end is defined here as an EDR electro-dialysis-stack. When a DC power supply is attached to the end electrodes, an electric field is created within the EDR electro-dialysis-stack that drives ions in the form of currents within it. An important property of EDR is that only cations can pass through cation exchange membranes and only anions can pass through anion exchange membranes.

The basic EDR operation is described as follows. Consider anyone of the concentrated saline water channels having two adjacent dilute saline water channels in the EDR electro-dialysis-stack. Cations, in a form of a current, are driven in one direction from an adjacent dilute saline water channel through a cation exchange membrane into the concentrated saline water channel and the anions, in a form of a current, are driven in the other direction from the other adjacent dilute saline water channel through an anion exchange membrane into the same concentrated saline water channel. In this way, the concentrated saline water channels gain both cations and anions from the two-adjacent dilute saline water channels which makes the concentrated saline water channel's water more saline and also preserves charge equilibrium. Next consider anyone of the dilute saline water channels having two adjacent concentrated saline water channels. Cations, in the form of a current, are driven out of the dilute saline water channel in one direction through the cation exchange membrane into an adjacent concentrated saline water channel and the anions, in the form of a current, are driven out of the dilute saline water channel in the other direction through the anion exchange membrane into the other adjacent concentrated saline water channel which makes the dilute saline water channel's water less saline and also preserves charge equilibrium. However, this process is interrupted at each end of the EDR electro-dialysis-stack were the electrodes are located because there is no adjacent ion exchange membrane and saline water channel to continue the process. Consequently, an electrochemical process takes place at the electrodes in which a gas is formed at one electrode by providing electrons to the ions and a different gas is formed at the other electrode by the electrode absorbing electrons from the ions. The EDR electro-dialysis-stacks always has cation exchange membranes nearest the electrodes and consequently there is always one more cation exchange membrane than anion exchange membranes. This arrangement will be slightly modified in this invention.

Capacitive deionization uses double layer supercapacitors, which can hold an extremely large number of cations within one supercapacitor electrode and anions within the other supercapacitor electrode, so that the capacitance of each electrode is extremely large compared to ordinary capacitors. The desalination process works by first inserting the saline water to be deionized between the two electrodes of the supercapacitor. Then by attaching a DC power supply to the two supercapacitor electrodes, one supercapacitor electrode is charged with cations while the other supercapacitor electrode is charged with anions. Thus, some of the ions present in the inserted saline water are drawn into the supercapacitor electrodes and are held there. The now saline water, which has been diluted in salinity to some extent, is removed from between the supercapacitor electrodes and the concentrated saline water is inserted between the supercapacitor electrodes. Then the supercapacitor electrodes are discharged sending their ions that were held in them into the concentrated saline water between the two supercapacitor electrodes which makes the concentrated saline water even more saline. This process is continuously repeated resulting in one saline water becoming less saline and the other saline water becoming more saline. The more common form of this arrangement, called membrane capacitive deionization, places a cation exchange membrane over the supercapacitor electrode that is attached to the negative terminal of the power supply and an anion exchange membrane over the supercapacitor electrode that is attached to the positive terminal of the power supply. Another means of operating capacitive deionization is to charge the supercapacitor electrodes by drawing in ions from the saline water stored in a tank of water to be diluted in salinity and then physically moving the supercapacitor electrodes into the concentrated water tank containing concentrated saline water to be concentrated in salinity and discharging them. This last operation pushes the ions out of the supercapacitor electrodes into the concentrated saline water. In the first capacitive deionization process discussed, two different saline waters are being moved in and out of the regions between the supercapacitor electrodes and in the second capacitive deionization process discussed, the supercapacitor electrodes are being physically moved between two sets of saline waters.

This invention uses modified forms of EDR that in part slightly changes the ion exchange membrane arrangement of EDR and replaces the conducting electrodes used in EDR with supercapacitor electrodes which are used in a similar manner as they are in capacitive deionization. No new fundamental technology is described in this invention beyond the new arrangement of old and well-known technologies and processes found in EDR and capacitive deionization. However, these well-known and used older technologies are arranged in a new manner so as to create a new devise that desalinates saline water which operates somewhat differently and has some different properties than current EDR and capacitive deionization configurations. No patents were found that are close to this invention beyond variations of the old and well-known EDR and capacitive desalination technologies used in this invention.

### BRIEF SUMMARY OF THE INVENTION

This CEDR invention is constructed using a forward CEDR electro-dialysis-stack and a reverse CEDR electro-dialysis-stack which are parallel to and near each other. The reverse CEDR electro-dialysis-stack is identical to the forward CEDR electro-dialysis-stack but is simply oriented in the opposite direction to the forward one. The forward and reverse CEDR electro-dialysis-stacks are defined as a stack of cation exchange membranes (C), anion exchange membranes (A), dilute saline water channel spacers (S_{D}), concentrated saline water channel spacers (S_{C}), end concentrated saline water spacers (S_{E}), and supercapacitor electrodes (E) that are arranged in an example having three dilute saline water channels as:
Forward: E, S_{E}, C, S_{D}, A, S_{C}, C, S_{D}, A, S_{C}, C, S_{D}, A, S_{E}, E and
Reverse: E, S_{E}, A, S_{D}, C, S_{C}, A, S_{D}, C, S_{C}, A, S_{D}, C, S_{E}, E.

The two supercapacitor electrodes located at one end of the forward and reverse CEDR electro-dialysis-stacks are exchanged in their locations at the end of each new cycle of operation. The same is true for the other two supercapacitor electrodes located at the other end. Each dilute saline water channel in the forward and reverse CEDR electro-dialysis-stacks are connected and each concentrated saline water channel in the forward and reverse CEDR electro-dialysis-stacks are connected as well.

The operational process is as follows. At the beginning of a cycle and while using a DC power supply, the supercapacitor electrodes located at the ends of each of the forward and reverse CEDR electro-dialysis-stacks discharges their ions previously stored there and then continues to charge them with ions of the opposite polarity. During this operation, the ions flow out of the dilute saline water channel into the concentrated saline water channel except at the ends where the ions flow in and out of the supercapacitor electrodes. Then the two supercapacitor electrodes located on the same end of the forward and reverse CEDR electro-dialysis-stacks are mechanically exchanged which is also the case on the other end. These two processes are continuously repeated. For this invention to operate properly, the supercapacitors on the same end of the two CEDR electro-dialysis-stacks must have opposite polarities.

The forward and reverse CEDR electro-dialysis-stacks operate in a similar manner to EDR electro-dialysis-stacks defined in the background section. The forward and reverse CEDR electro-dialysis-stacks has one less cation exchange membrane than the EDR electro-dialysis-stacks and utilize supercapacitor electrodes rather than conducting electrodes. The supercapacitor electrodes are similar to those used in capacitive deionization and ions flow in and out of them rather than make gasses as the EDR electro-dialysis-stack would using conducting electrodes.

### BRIEF DESCRIPTION OF THE SEVERAL VIEWS OF THE DRAWING(S)

FIG. 1: Isometric illustration of the exterior of this Capacitive Electro Dialysis Reversal (CEDR) Invention

FIG. 2: Isometric illustrations of the back view of the front supercapacitor electrode assembly on the left and of the front view of the rear supercapacitor electrode assembly on the right

FIG. 3: Isometric illustration of the front view of the anion/cation exchange membrane

FIG. 4: Isometric illustration of the front view of the cation/anion exchange membrane

FIG. 5: Isometric illustration of the front view of the dilute saline water channel spacer

FIG. 6: Isometric illustration of the front view of the concentrated saline water channel spacer

FIG. 7: Isometric illustration of the front view of the end channel spacer

FIG. 8: Isometric illustration of an incomplete separated CEDR electro-dialysis-stack with the end plate. The front supercapacitor electrode assembly is hidden from view. The CEDR electro-dialysis-stack includes end spacers, cation/anion exchange membranes, dilute saline water channel spacers, anion/cation exchange membranes, and concentrated saline water channels. The entire CEDR electro-dialysis-stack cannot properly viewed because it is incomplete.

FIG. 9: Illustration of the cross-sectional view along the centerline of the active components of the Capacitive Electro Dialysis Reversal CEDR invention showing the ions locations and their flow while the supercapacitor electrodes are discharging

FIG. 10: Illustration of the cross-sectional view along the centerline of the active components of the Capacitive Electro Dialysis Reversal CEDR invention showing the ions locations and their flow while the supercapacitor electrodes are charging

### DETAILED DESCRIPTION OF THE INVENTION

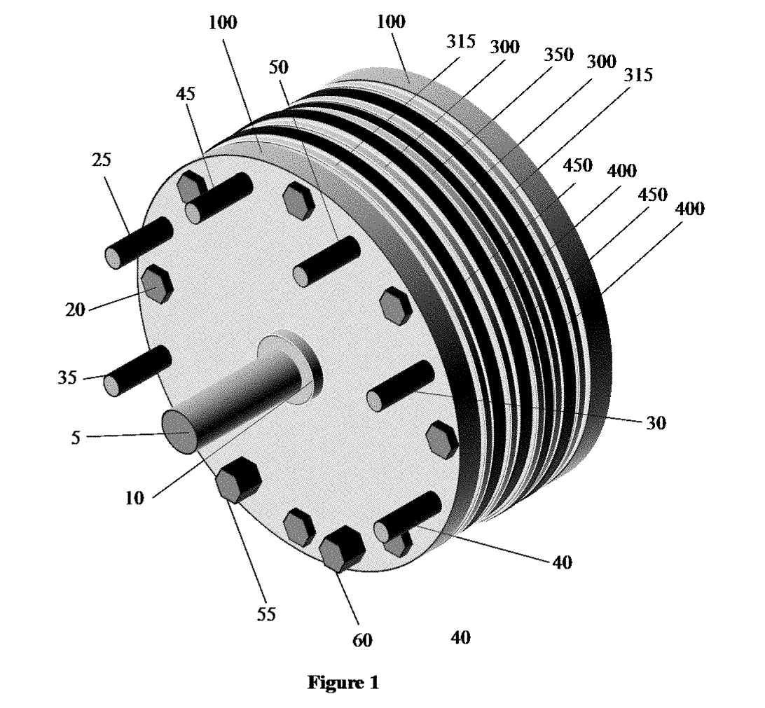

This Capacitive Electro Dialysis Reversal (CEDR) invention combines technologies found in Electro Dialysis Reversal (EDR) and capacitive deionization in a new way to desalinate and concentrate saline waters. An isometric front view illustration of the exterior of the CEDR invention is shown in FIG. 1. CEDR is composed of a stack of components bolted together. Specifically, there are front and rear end plates 100, front and rear supercapacitor electrode assemblies hidden from view as discussed later, multiple thin anion/cation exchange membranes 400, multiple thin cation/anion exchange membranes 450, multiple thin dilute saline water channel spacers 300, multiple thin concentrated saline water channel spacers 350, and two end spacers 315 all bolted together with bolts 20 where six are shown in this illustration. There are the same number of cation/anion exchange membranes as there are anion/exchange membranes and they must alternate in placement from front-to-back. There is significant similarity between these two ion exchange types to cation and anion exchange membranes of EDR, but there are differences as well as discussed later. The front and rear end plates 100 are identical. A cylindrical shaft 5 extends through a combined bearing and watertight seal 10 into the end plate 100 and it attaches to a supercapacitor electrode assembly that is hidden from view which is discussed subsequently. A motor, that is not shown and is attached to the shaft 5, is used to rotate the shaft 180 degrees when commanded to by a controller that is not shown as well. There are four water channels 45, 50, 55, and 60 that run the length of the cylinder. Water connectors for the dilute saline water are attached to dilute saline water channels 45 on the front-end plate 100 and dilute saline water channel 55 on the rear end plate 100. Water connectors for the concentrated saline water are attached to concentrated saline water channels 50 on the front-end plate 100 and concentrated saline water channel 60 on the rear end plate 100. The other holes for the water channels 55 and 60 on the front-end plate 100 and holes 45 and 50 on the rear-end plate 100 are plugged. Each end plate has a lower input concentrated saline water connector 35, lower output concentrated saline water connector 40, upper input concentrated saline water connector 25, and upper output concentrated saline water connector 30. The reason for the two-different input and output water systems on the end plates 100 is to improve electrical isolation as discussed later. If the electrical isolation is sufficient, the ends could simply use the concentrated saline water flow system of input 50 on the front and output 55 on the rear and the separate end water flow systems of 25, 39, 35, and 40 could be dispensed with. For a large system, the diameter of the CEDR unit might be 2 meters, have a thickness of 0.3 meters, and be composed of 50 dilute saline water channels.

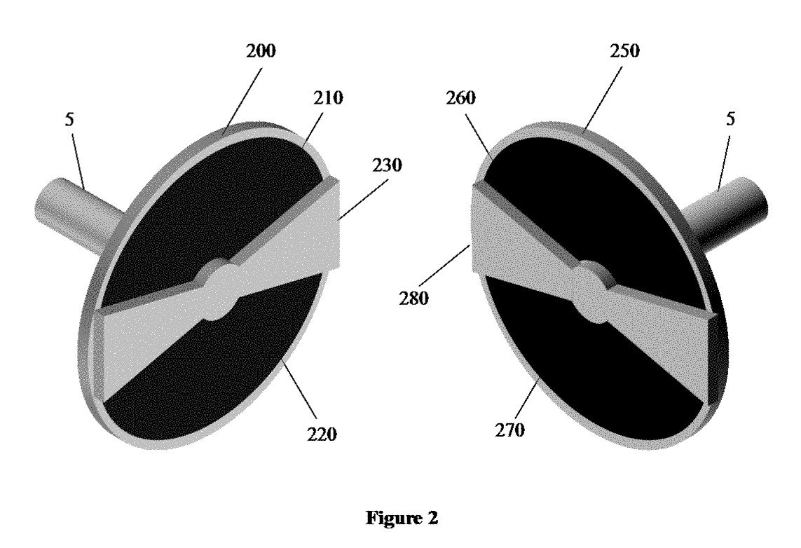

The isometric illustration of the back view of the front supercapacitor electrode assembly 200 on the left and the isometric illustration of the front view of the rear supercapacitor electrode assembly 250 on the right are shown in FIG. 2. There is a supercapacitor electrode 210 on the upper portion and a supercapacitor electrode 220 on the lower portion of the front supercapacitor electrode assembly 200. Also, there is a protruding dielectric 230 separating the upper and lower supercapacitor electrodes 210 and 220 respectively on the front supercapacitor electrode assembly 200. Similarly, there is a supercapacitor electrode 260 on the upper portion and a supercapacitor electrode 270 on the lower portion of the rear supercapacitor electrode assembly 250. Also, there is a protruding dielectric 280 separating the upper and lower supercapacitor electrodes 260 and 270 respectively on the rear supercapacitor electrode assembly 250. Each supercapacitor electrode assembly 200 and 250 have a shaft 5, as seen in FIG. 1, attached to it so the entire supercapacitor assemblies 200 and 250 can rotate. There are electrical conductors attached to each of the supercapacitor electrodes 210 and 220 that pass through the front shaft 5, through slip rings not shown, and out to power supplies with associated switches not shown. Similarly, there are electrical conductors attached to each of the supercapacitor electrodes 260 and 270 that pass through the rear shaft 5, through slip rings not shown, and out to power supplies with associated switches not shown. All portions of the supercapacitor electrode assemblies 200 and 250, except for the supercapacitor electrodes 210, 220, 260, and 270, conductors, and slip rings, are non-conducting. The diameter of the supercapacitor electrode assemblies 200 and 250 is less than the inside diameter of the outer wall formed by the stack of anion/cation exchange membranes 400, cation/anion exchange membranes 450, and all spacers 300, 350, and 315 shown in FIG. 1 as can be seen better later. This is required to allow the supercapacitor electrode assemblies 200 and 250 to rotate at the ends but yet be enclosed within the end plates 100 and end spacers 315. The protruding dielectrics 230 or 280 will be close to the central section of end spacers 315 as shown later so as to improve electrical isolation between the upper and lower supercapacitor electrodes 210 and 220 respectively on the front supercapacitor assembly 200 and between the upper and lower supercapacitor electrodes 260 and 270 respectively on the rear supercapacitor assembly 250 by allowing minimum saline water between the upper and lower supercapacitor electrodes when the supercapacitor electrode assemblies 200 and 250 are in either one of the two operating positions.

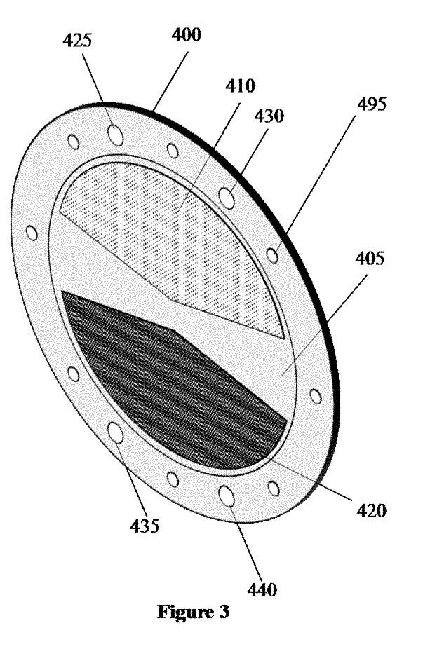

The front view of the anion/cation exchange membrane 400 is shown in an isometric illustration in FIG. 3. The entire anion/cation exchange membrane 400 is thin, flat on both sides, and constructed from a dielectric material except for the upper portion which is an anion exchange membrane 410 and for the lower portion which is a cation exchange membrane 420. The anion and cation exchange membranes extends completely through the thin disk. The center dielectric region 405 is the same thickness as all other areas of the anion/cation exchange membrane 400 and it is there to improve electrical isolation between the upper and lower electrically active regions. The hole 425 is a part of the input dilute saline water flow system and the hole 440 is a part of the output dilute saline water flow system. The hole 430 is a part of the input concentrated saline water flow system and the hole 435 is a part of the output concentrated saline water flow system. The holes 495, where there are six per anion/cation exchange membrane 400 as illustrated, are used to place bolts through the entire stack of anion/cation exchange membranes 400, cation/anion exchange membranes 450, and all spacers 300, 350, and 315 plus end plates 100 to hold it together.

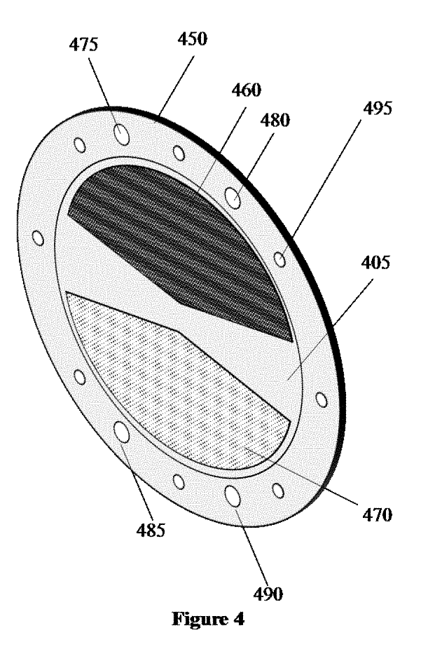

The front view of the cation/anion exchange membrane 450 is shown in an isometric illustration in FIG. 4. The entire cation/anion exchange membrane 450 is thin, flat on both sides, and constructed from a dielectric material except for the upper portion which is a cation exchange membrane 460 and for the lower portion which is an anion exchange membrane 470. The anion and cation exchange membranes extends completely through the thin disk. The center dielectric region 405 is the same thickness as all other areas of the cation/anion exchange membrane 450 and it is there to improve electrical isolation between the upper and lower electrically active regions. The hole 475 is a part of the input dilute saline water flow system and the hole 490 is a part of the output dilute saline water flow system. The hole 480 is a part of the input concentrated saline water flow system and the hole 485 is a part of the output concentrated saline water flow system. The holes 495, where there are six per cation/anion exchange membrane 450 as illustrated, are used to place bolts through the entire stack of anion/cation exchange membranes 400, cation/anion exchange membranes 450, and all spacers 300, 350, and 315 plus end plates 100 to hold it together. It should be noticed that the anion/cation exchange membrane 400 is the same as the cation/anion exchange membrane 450 except it is just rotated 180 degrees about a central horizontal axis.

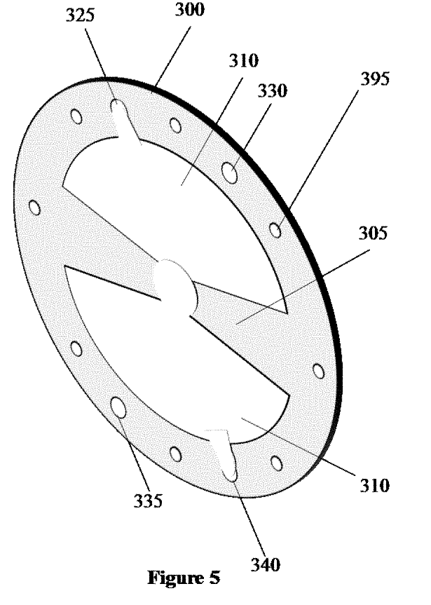

The front view of the dilute saline water channel spacer 300 is shown in an isometric illustration in FIG. 5. The entire dilute saline water channel spacer 300 is thin, flat on both sides, and constructed from a dielectric material which has matching gaskets attached to both of its sides. The center dielectric region 305 is the same thickness as all other areas of the dilute saline water channel spacer 300 and it is there to improve electrical isolation between the upper and lower electrically active regions. However, in this case, there is a cut out of the region 305 to allow dilute saline water to pass through it. The hole 325 is a part of the input dilute saline water flow system and the hole 340 is a part of the output dilute saline water flow system. These holes 325 and 340 also have a cutout so the dilute saline water will also pass into and out of the empty region 310 respectively. The hole 330 is a part of the input concentrated saline water flow system and the hole 335 is a part of the output concentrated saline water flow system. The holes 495, where there are six per dilute saline water channel spacer 300 as illustrated, are used to place bolts through the entire stack of anion/cation exchange membranes 400, cation/anion exchange membranes 450, and all spacers 300, 350, and 315 plus end plates 100 to hold it together.

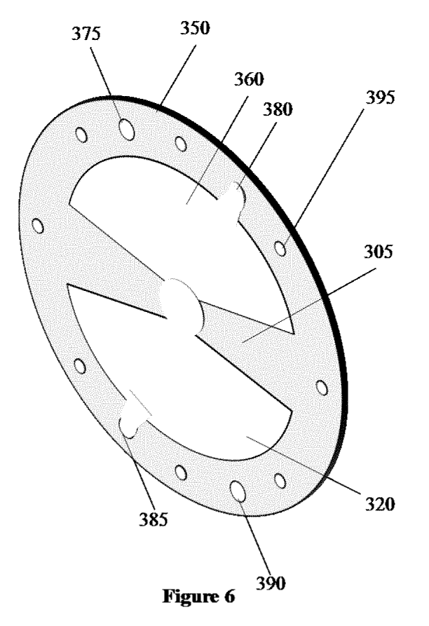

The front view of the concentrated saline water channel spacer 350 is shown in an isometric illustration in FIG. 6. The entire concentrated saline water channel spacer 350 is thin, flat on both sides, and constructed from a dielectric material which has matching gaskets attached to both of its sides. The center dielectric region 305 is the same thickness as all other areas of the concentrated saline water channel spacer 350 and it is there to improve electrical isolation between the upper and lower electrically active regions. However, in this case, there is a cut out of the region 305 to allow concentrated saline water to pass through it. The hole 375 is a part of the input dilute saline water flow system and the hole 390 is a part of the output dilute saline water flow system. The hole 380 is a part of the input concentrated saline water flow system and the hole 385 is a part of the output concentrated saline water flow system. These holes 380 and 385 also have a cutout so the concentrated saline water will also pass into and out of the empty region 360 respectively. The holes 495, where there are six per concentrated saline water channel spacer 350 as illustrated, are used to place bolts through the entire stack of anion/cation exchange membranes 400, cation/anion exchange membranes 450, and all spacers 300, 350, and 315 plus end plates 100 to hold it together.

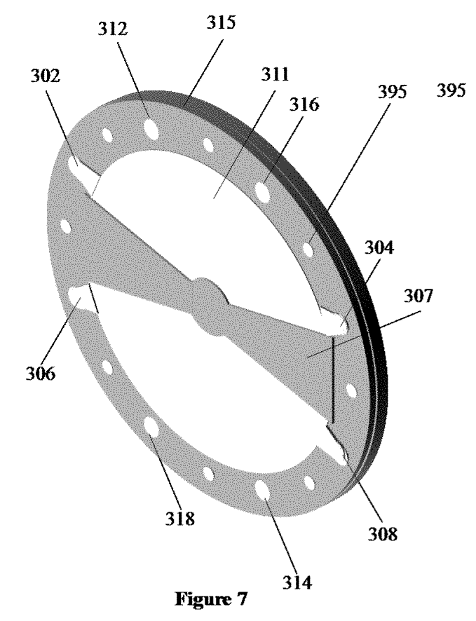

The front view of the end spacer 315 is shown in an isometric illustration in FIG. 7. The end spacer 315 is thin but thicker than the other spacers, flat on both sides with the exception of the central region 307, and constructed from a dielectric material which has matching gaskets attached to both of its sides. The center dielectric region 307 is not as thick as the other areas. The central region 307 lies flat against either the anion/cation exchange membrane 400 or cation/anion exchange membrane 450 on one side but is indented on the side facing either one of the supercapacitor electrodes assemblies 200 or 250 respectively. This is required so the supercapacitor electrodes 200 and 250 can fit within the cavity holding saline concentrated water. Furthermore, the central region 230 and 280 of FIG. 2 should fit very close to the central region 307 of FIG. 7 when the supercapacitor electrode assemblies 200 and 250 are in their operational positions so as to improve electrical isolation between the two supercapacitor electrodes 210 and 220 and between the two supercapacitor electrodes 260 and 270. However, the supercapacitor electrode assemblies 200 and 250 are free to rotate between their two operational positions. Hole 312 is a part of the input dilute saline water flow system and the hole 314 is a part of the output dilute saline water flow system. Hole 316 is a part of the input concentrated saline water flow system and the hole 318 is a part of the output concentrated saline water flow system. The holes and associated cutouts 302 and 306 on both the front and rear end spacers input concentrated saline water to the lower and upper cavities that are between the front supercapacitor electrode assembly 200 and the front cation/anion exchange membrane 450 and between the rear supercapacitor electrode assembly 250 and the rear anion/cation exchange membrane 400. The holes and associated cutouts 304 and 308 on both the front and rear end spacers drain the concentrated saline water from the lower and upper cavities that are between the front supercapacitor electrode assembly 200 and the front cation/anion exchange membrane 450 and between the rear supercapacitor electrode assembly 250 and the rear anion/cation exchange membrane 400. The holes 495, where there are six hole per end spacer as illustrated, are used to place bolts through the entire stack of anion/cation exchange membranes 400, cation/anion exchange membranes 450, and all spacers 300, 350, and 315 plus end plates 100 to hold it together.

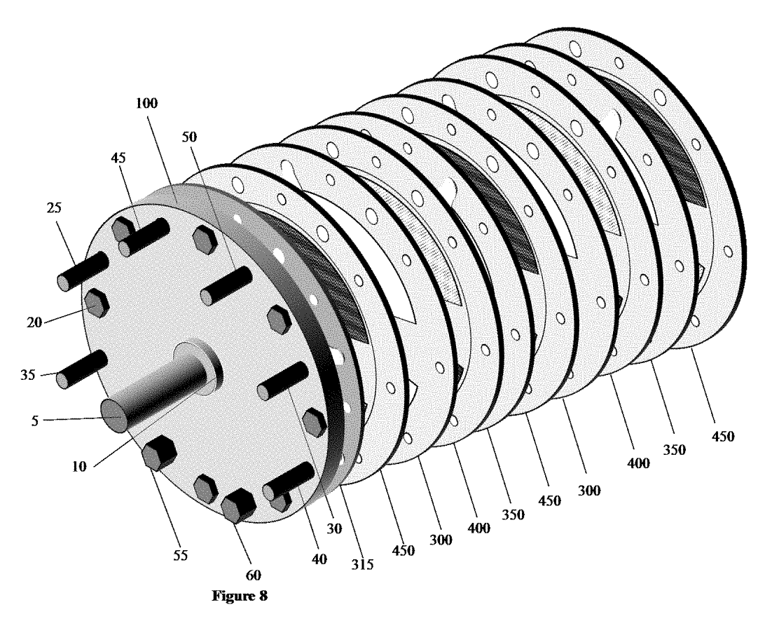

An isometric illustration of the incomplete CEDR invention, having a portion of its major components separated, is shown in FIG. 8. The subset of separated major components are composed of front end plate 100, end spacer 315, cation/anion exchange membranes 450, dilute saline water channel spacers 300, anion/cation exchange membranes 400, and concentrated saline water channel spacers 350. The supercapacitor electrode assemblies 200 and 250 are hidden from view. When a complete set of these components, that are not all shown in FIG. 8, are bolted together, they will form a forward CEDR electro-dialysis-stack and a reverse CEDR electro-dialysis-stack which are parallel to and near each other and are both located within the cylindrical walls formed by all the components except for the end plates 100. The reverse CEDR electro-dialysis-stack is identical to the forward CEDR electro-dialysis-stack but is simply oriented in the opposite direction to the forward one. The forward and reverse CEDR electro-dialysis-stacks consists of a stack of cation exchange membranes (C), anion exchange membranes (A), dilute saline water channel spacers (S_{D}), concentrated saline water channel spacers (S_{C}), end concentrated saline water spacers (S_{E}), and supercapacitor electrodes (E) plus end Plates (P) that are arranged in an example having three dilute saline water channels as:
Forward: P, E, S_{E}, C, S_{D}, A, S_{C}, C, S_{D}, A, S_{C}, C, S_{D}, A, S_{E}, E, P and
Reverse: P, E, S_{E}, A, S_{D}, C, S_{C}, A, S_{D}, C, S_{C}, A, S_{D}, C, S_{E}, E, P.

Both the dilute and concentrated saline water flow through the many holes and open spaces within the components of the CEDR invention and then back out the rear water connectors. The end result, is the dilute and concentrated saline water flows through the dilute and concentrated saline water channels between the ion exchange membranes and on the ends the concentrated saline water flows between the supercapacitor electrodes and the nearest ion exchange membrane to them. The supercapacitor electrode assemblies, except for the shafts 5 at the ends, are hidden from view, Even though not visible, these supercapacitor electrode assemblies are located in concentrated saline water and can rotate 180 degrees on demand.

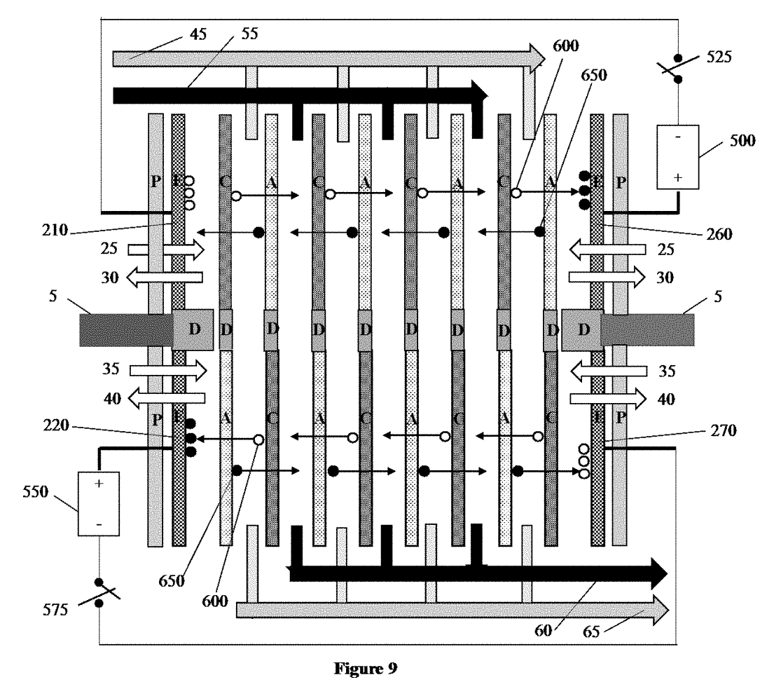

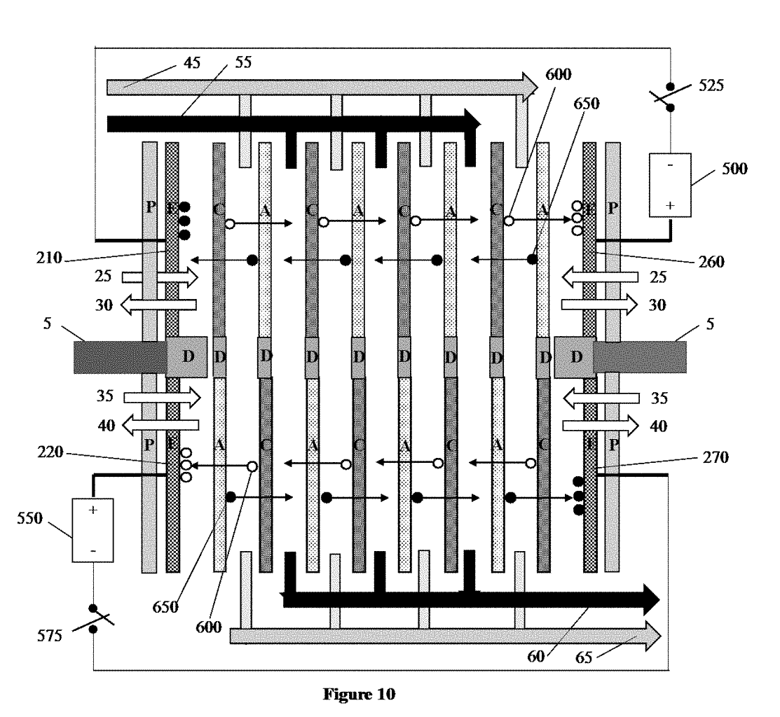

FIGS. 9 and 10 illustrate the active components of the CEDR invention for the purpose of describing its operation. These figures show a cross-sectional view of the components on the vertical plane through the center half way across from the side of the CEDR. The outer perimeter of the components is not shown but the location of the various saline waters is shown. From left to right the components are end plate 100, supercapacitor electrodes 210 and 220 of the supercapacitor electrode assembly 200, end spacer 315, cation/anion exchange membrane 450, dilute saline water channel spacer 300, anion/cation exchange membrane 400, concentrated saline water channel spacer 350, cation/anion exchange membrane 450, dilute saline water channel spacer 300, anion/cation exchange membrane 400, concentrated saline water channel spacer 350, cation/anion exchange membrane 450, dilute saline water channel spacer 300, anion/cation exchange membrane 400, concentrated saline water channel spacer 350, cation/anion exchange membrane 450, dilute saline water channel spacer 300, anion/cation exchange membrane 400, end spacer 315, supercapacitor electrodes 260 and 270 of the supercapacitor electrode assembly 250, and end plate 100. The cation exchange membranes are marked with the letter C. The anion exchange membranes are marked with the letter A. The supercapacitor electrodes 210, 220, 260, and 270 are marked with the letter E. The end plates 100 are marked with the letter P. The non-conducting dielectric material is marked with the letter D. The number of cation/anion exchange membranes 450 shown is four which is equal to the number of anion/cation exchange membranes 400 shown as four as well. The forward CEDR electro-dialysis-stack is shown in the upper portion and the reverse CEDR electro-dialysis-stack is shown in the lower portion of FIGS. 9 and 10. The forward and reverse CEDR electro-dialysis-stacks are similar to an EDR electro-dialysis-stack except an EDR electro-dialysis-stack would have a cation exchange membrane nearest each supercapacitor electrode for all cases and the electrodes would be conducting rather than being supercapacitor electrodes.

Again, observing FIGS. 9 and 10, the input dilute saline water 45 flows through the dilute saline water channels to the output dilute saline water flow 65. The input concentrated saline water 55 flows through the concentrated saline water channels to the output concentrated saline water flow 60. The input concentrated saline water 25 and 35 flows through the end plate 100 into the concentrated saline water region between the supercapacitor electrodes and the nearest either cation/anion or anion/cation exchange membranes. The output concentrated saline water 30 and 40 flows out of the concentrated saline water region between the supercapacitor electrodes and the nearest either cation/anion or anion/cation exchange membranes and through the end plates 100 respectively. The shaft 5 is used to rotate the supercapacitor assembly 200 containing the two supercapacitor electrodes 210 and 220 at the left end and the other shaft 5 is used to rotate the supercapacitor assembly 250 containing two supercapacitor electrodes 260 and 270 at the right end. These supercapacitor electrodes are rotated 180 degrees at the end of each supercapacitor electrode charging cycle. The negative terminal of a constant voltage power supply 500 is attached to a switch 525 which in turn is attached to the supercapacitor electrodes 210 while the positive terminal of the power supply 500 is attached to supercapacitor electrode 260. The negative terminal of a constant voltage power supply 550 is attached to a switch 575 which in turn is attached to the supercapacitor electrodes 270 while the positive terminal of the power supply 550 is attached to supercapacitor electrode 220. The power supply 500 is always attached to the upper forward CEDR electro-dialysis-stack and the power supply is always attached to the lower reverse CEDR electro-dialysis-stack. This condition requires brushes, not shown, to allow for the supercapacitor capacitor assemblies 200 and 250 to rotate and maintain this polarity condition or the same power supplies 500 and 550 could be permanently attached to the same supercapacitor electrodes without brushes and have their polarity swapped every cycle of operation. The anions 600 are represented by a small circle and if an arrow is attached to them, the arrow shows the direction of flow. The cations 650 are represented by a small solid dot and if an arrow is attached to them, the arrow shows the direction of flow.

The operation of the CEDR invention is as follows. After a charging cycle, has been completed and the supercapacitor electrode assemblies 200 and 250 have rotated 180 degrees, there is an initial charge on the supercapacitor electrodes indicated by anions 600 stored in the supercapacitor electrodes 210 and 270 and cations 650 stored in the supercapacitor electrodes 220 and 260. The switches 525 and 575 closes. An electric field is set up between the supercapacitor electrodes 210 and 260 as well as between supercapacitor electrodes 220 and 270 but in the opposite direction as the one between supercapacitor electrodes 210 and 260. These electric fields drive the anions and cations in opposite directions in the forward and reverse CEDR electro-dialysis-stacks respectively as shown by arrows on the anions and cations in FIG. 9. Further observing FIG. 9, and momentarily excluding the end concentrated saline water channels, the dilute saline water in the dilute saline water channels are losing ions and the concentrated saline water in the concentrated saline water channels are gaining cations and ions. The operation is different at the ends where the supercapacitor electrodes are located. While the supercapacitor electrodes are discharging, the supercapacitor electrode 210 is releasing anions 600 due to the supercapacitor electrode discharging but gaining cations 650 so the concentrated saline water is becoming more concentrated in salinity at the supercapacitor electrode 210. Similarly, the supercapacitor electrode 270 is releasing anions 600 due to the supercapacitor electrode discharging but gaining cations 650 so the concentrated saline water is becoming more concentrated in salinity at the supercapacitor electrode 270. Similarly, the supercapacitor electrode 260 is releasing cations 650 due to the supercapacitor electrode discharging but gaining anions 600 so the concentrated saline water is becoming more concentrated in salinity at the supercapacitor electrode 260. Similarly, the supercapacitor electrode 220 is releasing cations 650 due to the supercapacitor electrode discharging but gaining anions 600 so the concentrated saline water is becoming more concentrated in salinity at the supercapacitor electrode 220. The supercapacitor electrodes 210, 220, 260, and 270 discharging process continues until they have completely discharged their initially stored ions and then they start to charge up with ions having a polarity opposite to their initial polarity which is described next.

FIG. 10 illustrates the continuing CEDR invention operation after the supercapacitor electrodes 210, 220, 260, and 270 have discharged all their ions initially stored there and begin to charge up with ions of a polarity opposite to their initial polarity. By observing FIG. 10, and momentarily excluding the end concentrated saline water channels, the dilute saline water in the dilute saline water channels are losing cations and anions while the concentrated saline water in the concentrated saline water channels are gaining cations and ions just like shown in FIG. 9 during the supercapacitor discharge operations. However, the operation is different at the ends where the supercapacitor electrodes 210, 220, 260, and 270 are located. In this case, cations 650 are arriving at the supercapacitor electrodes 210 and 270 are just stored there and anions 600 are arriving at the supercapacitor electrodes 220 and 260 are just stored there. This process continues until the supercapacitor electrodes 210, 220, 260, and 270 are fully charged. The switches 525 and 575 are opened and the shaft 5 and associated supercapacitor electrode assembly 200 containing the two supercapacitor electrodes 210 and 220 at the left end is rotated 180 degrees and the other shaft 5 and associated supercapacitor electrode assembly 250 containing the two supercapacitor electrodes 260 and 270 at the right end is rotated 180 degrees as well. The supercapacitor electrode discharge process just described using FIG. 9 is performed again followed by this supercapacitor electrode charge process described here in FIG. 10 are repeated continuously. One should note that there is twice the concentration of ions forming a higher salinity salt solution at the supercapacitor electrodes 210, 220, 260, and 270 during the supercapacitor electrode discharging process as there are ions leaving the nearest ion exchange membrane. But half of these ions is being supplied by the ions initially stored in the supercapacitor electrodes 210, 220, 260, and 270 which were provided during the supercapacitor electrode charging process in the previous cycle where no additional increase in salinity of the saline water is formed and the ions arriving at the supercapacitor electrodes are simply stored. So, there is charge conservation. In summary, the concentrated saline water in the concentrated saline water channels is becoming more saline and the dilute saline water in the dilute saline water channels is becoming less saline throughout the forward and reverse CEDR electro dialysis-stacks except on the ends where the ions simply flow into and out of the supercapacitor electrodes. Because there are no electrochemical reactions on the supercapacitor electrodes, there are no gasses formed. Finally, it should be noticed that if the polarities of the power supplies are reversed and the dilute saline water channels and concentrated saline water channels are swapped, the CEDR invention can be operated in reverse just like the conventional EDR units.

Before moving on, a few comments are made about the leakage currents that can degrade performance. The ratio of the diameter to the thickness of the CEDR unit impacts the leakage current. If this ratio is large, most of the electric field is contained between the two end supercapacitor electrodes of either the forward or reverse CEDR electro-dialysis-stack and there is little leakage of current between the forward and reverse CEDR electro-dialysis-stacks. If the forward and reverse CEDR electro-dialysis-stacks are encased mostly in a dialectic material and the saline water inside has a high conductivity, there is little current leakage between the two stacks. There is a balance between the size of the opening in the center of the dilute and concentrated saline water spacers. If this opening is large which improves saline water flow, the leakage current is greater and vice versa. On the ends, as long as the spacing between the center dielectric of the end spacer and the dielectric center piece of the supercapacitor electrode assembly is very small, there is little leakage current between the upper and lower supercapacitor electrodes. So, by employing design tradeoffs, the leakage currents can be managed.

First Order Desalination Example: A first order example CEDR unit and its desalination operational performance is provided. All cation exchange membranes 420 and 460 and anion exchange membranes 410 and 470 of the cation/anion exchange membranes 450 and anion/cation exchange membranes 400 have areas of 1 square meter and have a thickness of 0.0005 meters. They are all spaced 0.0025 meters (m) apart. The electrical resistance to ion flow for each cation and anion exchange membrane of this one square meter area is assumed to be 0.002 ohms. Similar to EDR, the limiting current through the cation and anion exchange membranes is assumed to be 500 amperes per square meter and therefore the maximum current for a one square meter ion exchange membrane is 500 amperes. Therefore, the voltage, being the resistance times the current, yields 1 volt drop across each ion exchange membrane.

The salinity of the concentrated and dilute saline waters is assumed to be 10,000 ppm and 3,000 ppm respectively and their associated resistivity's are 0.75-ohm meter and 2.5-ohm meter respectively. For an area of 1 square meter and a thickness of 0.0025 meters, the resistance across the concentrated and dilute saline water channels can be calculated using the resistivity times the thickness divided by the area to yield 0.001875 ohms and 0.00625 ohms respectively. The voltages across each concentrated and dilute saline water channels are then computed by multiplying the resistance times the current to yield 0.9375 and 3.125 volts respectively.

The CEDR unit is assumed to be composed of 50 anion/cation exchange membranes and 50 cation/anion exchange membranes which will provide 50 dilute saline water channels, 49 concentrated saline water channels, and 2 end concentrated saline water channels. The thickness of the forward and reverse CEDR electro-dialysis-stacks, not including the two supercapacitor electrode assemblies and end plates is computed by multiplying the thickness of the cation or anion ion exchange membranes plus the thickness of the dilute or concentrated saline water channels all times 101 to obtain about 0.3 meters. The total resistance and voltage across either of the forward or reverse CEDR electro-dialysis-stack is obtained by adding up the resistances and the voltages across the electro-dialysis-stack to obtain about 0.62 ohms and 305 volts respectively. The current through either the forward or reverse CEDR electro-dialysis-stack is 500 amperes.

Each supercapacitor electrode of the supercapacitor assemblies 200 and 250 has an area of one square meter, capacitance C of 10,000 Farads, and a maximum voltage it can be charged to of V equal to one volt. Since, the voltage across either the forward or reverse CEDR electro-dialysis-stack is about 305 volts and the voltage across the supercapacitor electrodes varies from minus one to plus one volt, the current is nearly constant during all the time the supercapacitors electrodes are discharging or charging. This current I is approximated to be constant and have a value of the 500 amperes. The time T for anyone of the supercapacitor electrodes to discharge from a voltage of −V and charge to a voltage V of opposite polarity can then be computed by

2V=IT/C

Computing T yields 40 seconds. So, at the end of the supercapacitor charging time, switches 525 and 575 open, the supercapacitor electrode assemblies 200 and 250 each rotate 180 degrees. The next cycle starts by closing switches 525 and 575, the supercapacitor electrodes on the supercapacitor electrode assemblies 200 and 250 discharge, and then charge to the opposite polarity that existed at the start of this cycle. Both the discharge and charge operations pull ions out of the dilute saline water channels and place them in the concentrated water channels except at the ends where the ions simply flow out of and into the supercapacitor electrodes. Assuming the time to rotate the supercapacitor electrode assemblies 200 and 250 is 2 seconds. The duty cycle D of the operation is

D=40/(40+2)=0.95.

The energy E_{S} used in one cycle of time T=40 seconds for both forward and reverse CEDR electro-dialysis-stacks after converting to kilowatt hours' (kWhr) is

E_{S}=2I²R T=3.4kWhr

The energy E_{C} used in one cycle of time T=40 seconds in charging the two supercapacitor electrodes associated with either the forward or reverse CEDR electro-dialysis-stack and changing their voltage from V=0 to V=1 volt after converting to kWhr is

E_{C}=2×½CV²=10,000 Farads×1 volt squared=0.0028 kWhr

The energy used in discharging the supercapacitor electrodes is the same as for charging the supercapacitor electrodes but this is the same energy as was initially stored in the supercapacitor electrodes so there is no net gain or loss in energy in discharging the supercapacitor electrodes. But energy E_{C} is required to charge the supercapacitor electrodes from zero volt to one volt. In conclusion, the energy used in discharging and charging the supercapacitor electrodes is very small relative to the energy used in pushing the current through the forward and reverse CEDR electro-dialysis-stacks, so it can be ignored.

The weight of salt transferred out of all the dilute saline water channels into the concentrated saline water channel in one cycle of T=40 seconds is computed with the aid of Faraday's Law which states the passage of 96,500 amperes of current for one second will transfer one mole of salt. For sodium chloride, one mole weighs 58.4 grams. So, the weight W of salt transferred in time T=40 seconds for this CEDR example having both forward and reverse CEDR electro-dialysis-stacks and 50 dilute saline water channels is:

W=2×50{(500 amperes×40 seconds)/96,500 ampere seconds)}×58.4 grams
W=1.2 kilograms (kg)

The mass flow rate R of salt after converting to kg per hour is computed by dividing the mass transferred in one cycle divided by the time for one cycle giving

R=1.2 kg/40 seconds=108 kg per hour (238 pounds per hour)

Using the energy used in one cycle and the weight of salt transferred in one cycle, the energy used per kilogram of salt transfer E/W then is

E/W=3.4 kWhr/1.2 kg=4.1 kWhr/kg

If electricity cost 10 cents a kWhr the cost to transfer 1 kg of salt is about 28 cents for the salinities of the dilute and concentrated saline waters given in the example.

A benefit of this CEDR inventions is that it operates with about the same performance as EDR. But unlike EDR, no gasses are formed at the supercapacitor electrodes as long as the operations remain within their design parameters. However, if the voltage that the supercapacitors charge to exceeds their maximum voltage, often in this case near one volt, gasses are formed. Furthermore, the current must stay below the limiting current of the cation and anion exchange membranes. A proper design would include measuring the voltages and the current in the CEDR invention to insure its proper operation. If the operational parameters become out of specification, then either steps must be taken to correct them or equipment maintenance must be performed. A feature of this CEDR invention is that almost all the power delivered to the CEDR invention is used to desalinate and concentrate the saline waters into two independent saline water streams within the forward and reverse CEDR electro-dialysis-stacks and little to negligible power relative to the power used in desalination is required at the supercapacitor electrodes located on the ends of the CEDR unit.

1-4. (canceled)

5. A capacitive electrodialysis devise comprising:
a. an electrodialysis stack that is formed with a stack of separated alternating anion and cation ion exchange membranes having independent low and high salinity water channels located between each alternating pair of anion and cation ion exchange membranes where portions of an electrodialysis system is an example;
b. electrodes formed as supercapacitors which are capable of absorbing or dispensing ions in the presence of saline water and an electric field where portions of a capacitive desalination system is an example;
c. a said capacitive electrodialysis devise is composed of a pair of said electrodes placed at each end of the said electrodialysis stack and has independent saline water separating the said electrodes and said electrodialysis stack;
d. during designated times, a voltage is applied to the said electrodes at each end of the said capacitive electrodialysis devise which causes ions in the saline waters to flow such as to further dilute the saline water in the low salinity water channels and to further concentrate the saline water in the high salinity water channels of the said electrodialysis stack as well as to cause ions to flow in the saline waters located between the said electrodes and the said electrodialysis stack where the ions directions of flow are determined by the polarity of the ions and the polarity of the voltage applied to each said electrode;
e. two identical and independent said capacitive electrodialysis devises each of which is composed of said electrodes at each end of the said electrodialysis stacks are placed near to each other where an example is adjacent and parallel to, and
f. during designated times, an electromechanical mechanism is used to exchange a said electrode of one of the said capacitive electrodialysis devises with a said electrode of the other neighborly said capacitive electrodialysis devise.

6. The two said capacitive electrodialysis devises of claim 1 are operated using a desalination/concentration process comprising:
a. at the initialization time of the said desalination/concentration process, a direct current power supply is attached to the two said electrodes of one of the said capacitive electrodialysis devices such that the polarities of the ions stored in each of its said electrodes matches each of the terminal polarities of the direct current power supply attached to it and likewise another direct current power supply is attached to the two said electrodes of the other said capacitive electrodialysis device such that the polarities of the ions stored in each of its said electrodes matches each of the terminal polarities of the direct current power supply attached to it;
b. as time proceeds, ions stored in the four said electrodes flow out of them and ions of the opposite polarity flow out of the four associated ends of the two said electrodialysis stacks such that the four saline waters located between each of the four said electrodes and their associated ends of the two said electrodialysis stacks becomes more saline as well as net charge neutrality is preserved;
c. simultaneously in time to the time described in claim 2b, the ions within the said electrodialysis stacks flow from the low salinity water channels through anion and cation ion exchange membranes to the high salinity water channels such as to make the low salinity water channel's water less saline and the high salinity water channel's water more saline;
d. after the said electrodes are completely depleted of the ions initially stored in them, the ions flowing toward each of the said electrodes from the two associated ends of the two said electrodialysis stacks continue to flow and are collected on the said electrodes where the polarity of the ions collected on each said electrode is opposite to the polarity of the power supply terminals attached to it;
e. when a point in time is reached when an electrolysis process would begin to function at the said electrodes due to the voltage across the electrode, the direct current power supplies are disengaged and the two said electrodes of one said capacitive electrodialysis devise are exchanged with the two said electrodes of the other said capacitive electrodialysis devise using the said electromechanical devises of claim if and according to the rule that said electrodes having opposite polarity voltages are the ones exchanged, and
f. after the said electrodes from two different said capacitive electrodialysis devises are exchanged, the said desalination/concentration process as described in claims 2a through 2e is repeatedly executed.

7. The said capacitive electrodialysis devises described in claim 1 and the said desalination/concentration process using them as described in claim 2 operates such that
a. there are no chemical reactions such as the formation of gases as found at the electrodes in similar electrodialysis systems, and
b. does not require the higher and lower salinity waters to be exchanged between each supercapacitor said electrode charging and discharging operations as found in similar capacitive desalination systems.
